(19) United States
(12) Patent Application Publication
(10) Pub. No.: US 2022/0380236 A1
(43) Pub. Date: Dec. 1, 2022

(54) HIGH EFFICIENCY ELECTRODIALYSIS FLUID PURIFICATION DEVICE AND METHOD

(71) Applicant: The Board of Trustees of the University of Illinois, Urbana, IL (US)

(72) Inventors: Aaron T. Timperman, Urbana, IL (US); Dayi Chen, Urbana, IL (US); Jin-Tae Kim, Savoy, IL (US); Leonardo P. Chamorro, Mahomet, IL (US)

(21) Appl. No.: 17/750,712

(22) Filed: May 23, 2022

Related U.S. Application Data
(60) Provisional application No. 63/193,716, filed on May 27, 2021.

(51) Int. Cl. C02F 1/469; C02F 1/42

(52) U.S. Cl. CPC C02F 1/4693; C02F 1/42; C02F 2201/4616

(57) ABSTRACT

An electrodialysis fluid purification device includes a fluid output from an upper part of a first fluid reservoir. One or more ion permselective elements at a surface on or near the bottom of the first reservoir are arranged to provide one or more small area points or lines. A fluid connection to a second fluid reservoir is on an opposite side of the one or more ion permselective elements. Electrodes and a power supply create a voltage differential across the one or more ion permselective elements. Another fluid purification device includes a first reservoir with which an ion permselective element interfaces directly in a 2D to 3D relationship. A method employs small area ion permselective element interfaces at a surface on or near the bottom of the first reservoir such that ion transport creates a depleted zone that extends into the first fluid reservoir.

### PRIORITY CLAIM AND REFERENCE TO RELATED APPLICATION

The application claims priority under 35 U.S.C. § 119 and all applicable statutes and treaties from prior U.S. provisional application Ser. No. 63/193,716 which was filed May 27, 2021.

### STATEMENT OF GOVERNMENT INTEREST

This invention was made with government support under Grant No. R01 EB025268 awarded by the National Institutes of Health. The government has certain rights in the invention.

### FIELD

Fields of the invention include electrodialysis and microfluidics. Preferred applications of the invention include water purification and other applications of electrodialysis for fluid treatment, including, e.g., lithium chloride purification, organic acids including lactic acid, water reclamation from metal or petroleum or other industrial waste, ethylsulfonomethane purification, phosphoric acid production, and medical dialysis. Another application is within an artificial kidney.

### BACKGROUND

Electrodialysis is used to treat fluids and obtain a desired output that is a component of an input fluid with other components removed, i.e., the output fluid is a desired purification of the input fluid. This process has various applications, as mentioned in the previous paragraph. Water desalination is an example, where the input fluid is water with salt and the output fluid is water that has been desalinated to a significant degree.

In conventional water desalination by electrodialysis, the impact of the loss of efficiency at higher applied voltage is so significant that the systems are typically operated at a low voltage to avoid strong ion concentration polarization (CP) despite lower product yield at lower voltage. [1-2]. This is true in conventional systems despite substantial research that has focused on improving the efficiency of ion transport in systems that induce CP. [3-4] CP is induced by the application of an electric field across an ion-permselective element and forms characteristic ion enriched and ion depleted zones on opposite sides of the ion-permselective element.

With its heterogeneous ion distributions, CP provides a technique to control the transport of ions and manipulate the local electric field in fluidic systems. [5] The uses and applications of CP include ion-exchange membrane separation processes [6-7], including water purification by electrodialysis. [4]. At constant applied voltage, higher current generally correlates with greater efficiency and improved performance. However, when CP is induced in these applications, the overall current is smaller than the no CP case.

In a conventional water dialysis device with an ion permselective element with a negative surface charge, the orientation of the enriched and depleted zones with respect to the applied voltage is shown in FIG. 1A. With an ion-permselective element with a negative surface charge, the anion (co-ion) transport is suppressed, and cation (counter-ions) transport is enhanced. Consequently, ion transport and current are carried by counter-ions through the ion-permselective element. A conventional microfluidic electrodialysis system shown in FIG. 1B includes a depleted zone in a microchannel connecting two reservoirs.

The current and voltage characteristic of the FIGS. 1A and 1B conventional devices are shown in FIG. 1D. The dashed line extrapolated from the Ohmic range represents Ohms' law scaling. The slope of the over-limiting region is less than the slope of the Ohmic region in conventional systems. The total resistance of the system is the sum of the resistances of the depleted side, the ion-permselective element, and the enriched side. Because the concentrations of both the anions and cations are low in the depleted zone, it has very high resistance, reducing the current and mass transport. In classic systems, the high resistance of the depleted zone helps form the I-V curve that has three distinct regions: i) Ohmic, ii) limiting, iii) and overlimiting (FIG. 1D). In the conventional systems, the high resistance of the depleted zone provides a barrier to better performance.

A number of strategies have been used to increase current in applications such as energy transfer. Many examples require additional energy input, such as adding a microheater [8], an electrode array [9], and flow [10]. A pillar array on the surface of a conventionally oriented ion-permselective element that did not require additional energy input increased convection and produced small gains in the current. [11] The Ohm's law current limit has only been exceeded by a small amount (≤10%) in systems that use a nanocapillary membrane (NCM) to couple a macroscale reservoir and microchannel. [12-14]. high currents have also been observed experimentally in a single nanochannel and a 400 nm-2 μm conical pore filled with nanoporous polylysine gel. [15-17]. In these extremely small systems, the ion diffusion length (100-200 μm) [18] is sufficient to overcome the depleted zone.

### REFERENCE LIST

1. A. A. Sonin and M. S. Isaacson, Industrial & Engineering Chemistry Process Design and Development, 1974, 13, 241-248.

2. K. M. Chehayeb, D. M. Farhat, K. G. Nayar and J. H. Lienhard, Desalination,

3. I. Rubinstein and L. Shtilman, Journal of the Chemical Society, Faraday Transactions 2: Molecular and Chemical Physics, 1979, 75, 231-246.

4. M. La Cerva, L. Gurreri, M. Tedesco, A. Cipollina, M. Ciofalo, A. Tamburini and G. Micale, Desalination, 2018, 445, 138-148.

5. M. Li and R. K. Anand, Analyst, 2016, 141, 3496-3510.

6. H. Strathmann, in Ullmann's Encyclopedia of Industrial Chemistry, 2011, DOI: 10.1002/14356007.016_o05.

7. I. Stenina, D. Golubenko, V. Nikonenko and A. Yaroslavtsev, Int J Mol Sci, 2020, 21.

8. S. Park and G. Yossifon, Nanoscale, 2018, 10, 11633-11641.

9. S. Park and G. Yossifon, Phys Rev E, 2016, 93, 062614.

10. I. Cho, G. Y. Sung and S. J. Kim, Nanoscale, 2014, 6, 4620-4626.

11. K. Huh, S. Y. Yang, J. S. Park, J. A. Lee, H. Lee and S. J. Kim, Lab Chip, 2020, 20, 675-686.

12. H. Wang, V. V. Nandigana, K. D. Jo, N. R. Alum and A. T. Timperman, Anal Chem, 2015, 87, 3598-3605.

13. K. C. Kelly, S. A. Miller and A. T. Timperman, Analytical Chemistry, 2009, 81, 732-738.

14. S. A. Miller, K. C. Kelly and A. T. Timperman, Lab Chip, 2008, 8, 1729-1732.

15. C.-Y. Lin, C. Combs, Y.-S. Su, L.-H. Yeh and Z. S. Siwy, Journal of the American Chemical Society, 2019, 141, 3691-3698.

16. S. J. Kim, Y. C. Wang, J. H. Lee, H. Jang and J. Han, Phys Rev Lett, 2007, 99, 044501.

17. C.-Y. Li, Z.-Q. Wu, C.-G. Yuan, K. Wang and X.-H. Xia, Analytical Chemistry, 2015, 87, 8194-8202.

18. A. Kozmai, V. Nikonenko, N. Pismenskaya, O. Pryakhina, P. Sistat and G. Pourcelly, Russian Journal of Electrochemistry, 2010, 46, 1383-1389.

### SUMMARY OF THE INVENTION

A preferred electrodialysis fluid purification device includes a fluid output from an upper part of a first fluid reservoir. One or more ion permselective elements at a surface on or near the bottom of the first reservoir are arranged to provide one or more small area points or lines. A fluid connection to a second fluid reservoir is on an opposite side of the one or more ion permselective elements. Electrodes and a power supply create a voltage differential across the one or more ion permselective elements.

A preferred fluid purification device includes a first reservoir with which an ion permselective element interfaces directly in a 2D to 3D relationship, an outlet channel for the clean water in an upper part of the first reservoir, a input channel into the first reservoir for raw water, an outlet channel at or near the bottom of the first reservoir to remove water that is enriched in contaminants, a second reservoir that is in fluid communication with the first reservoir through the ion permselective element, and electrodes to provide an applied electric field between the first and second reservoirs.

A preferred method for fluid purification through electrodialysis provides a first reservoir for clean fluid collection and introduction of raw fluid. A small area ion permselective element is arranged to interface at a surface on or near the bottom of the first reservoir such that ion transport creates a depleted zone that extends into the first fluid reservoir. Feed fluid is introduced to the interfaces in the first reservoir. Ionic fluid transport is created across the interfaces into the second reservoir. Clean fluid is collected from an upper part of the first reservoir.

### BRIEF DESCRIPTION OF THE DRAWINGS

FIGS. 1A-1B (Prior Art) are schematic diagrams of conventional electrodialysis systems;

FIG. 1C is a schematic diagram of a preferred electrodialysis fluid purification device;

FIG. 1D (Prior Art) is the I-V curve of the FIGS. 1A-1B devices that has three distinct regions: i) Ohmic, ii) limiting, iii) and overlimiting;

FIG. 1E shows typical I-t and I-V plots provided by preferred purification devices;

FIGS. 2A-B show a preferred water purification device in respective side schematic and partial bottom views;

FIGS. 3A-3B show side view and top partial views of a preferred microfluidic water purification device;

FIGS. 3C-3F are testing data concerning an experimental device consistent with FIGS. 3A-3B;

FIGS. 4A-4E are diagrams of experimental devices used for depletion zone testing; and

FIGS. 5A and 5B illustrate XYZT and YZT scan modes for imaging of experimental devices during depletion zone testing.

### DETAILED DESCRIPTION OF THE PREFERRED EMBODIMENTS

A preferred embodiment is an electrodialysis fluid purification device. The device includes a feed fluid supply into a first fluid reservoir. A fluid output is taken from an upper part of the first fluid reservoir. One or more ion permselective elements are at a surface on or near the bottom of the first reservoir, the one or more ion permselective elements being arranged to provide one or more small area points or lines. A fluid connection to a second fluid reservoir is on an opposite side of the one or more ion permselective elements. Electrodes and a power supply create a voltage differential across the one or more ion permselective elements.

An electrodialysis fluid purification device of the invention includes a feed fluid supply into a first fluid reservoir. A fluid output is from an upper part of the first fluid reservoir. One or more ion permselective elements are at a surface on or near the bottom of the first reservoir. A fluid connection is to a second fluid reservoir on an opposite side of the one or more ion permselective elements. Electrodes and a power supply create a voltage differential across the one or more ion permselective elements. The one or more ion permselective elements are arranged to present a microscale interface to a macroscale volume of the first fluid reservoir.

A method for fluid purification through electrodialysis includes providing a first reservoir for clean fluid collection and introduction of raw fluid. The method also includes arranging small area ion permselective element interfaces at a surface on or near the bottom of the first reservoir such that ion transport creates a depleted zone that extends into the first fluid reservoir. Feed fluid is introduced to the interfaces in the first reservoir. Ionic fluid transport is created across the interfaces into the second reservoir. Clean fluid is collected from an upper part of the first reservoir.

An electrodialysis fluid purification device includes a channel/tube for removal of water that is enriched in the contaminants (referred to as the brine in desalination) in the first reservoir. A preferred device includes a first reservoir with which the ion permselective element interfaces directly in a 2D to 3D relationship, an outlet channel for the clean water near the top, a input channel for raw water, an outlet channel at or near the bottom to remove water that is enriched in contaminants, a second reservoir that is in fluid communication with the first reservoir through the ion permselective element, and electrodes to provide an applied electric field between the first and second reservoirs.

An ion permselective element, as used herein, can be a charged gel, charged membrane, or nanochannel etc. The ion permselective element must induce concentration polarization.

Preferred embodiments of the invention will now be discussed with respect to experiments and drawings. Broader aspects of the invention will be understood by artisans in view of the general knowledge in the art and the description of the experiments that follows.

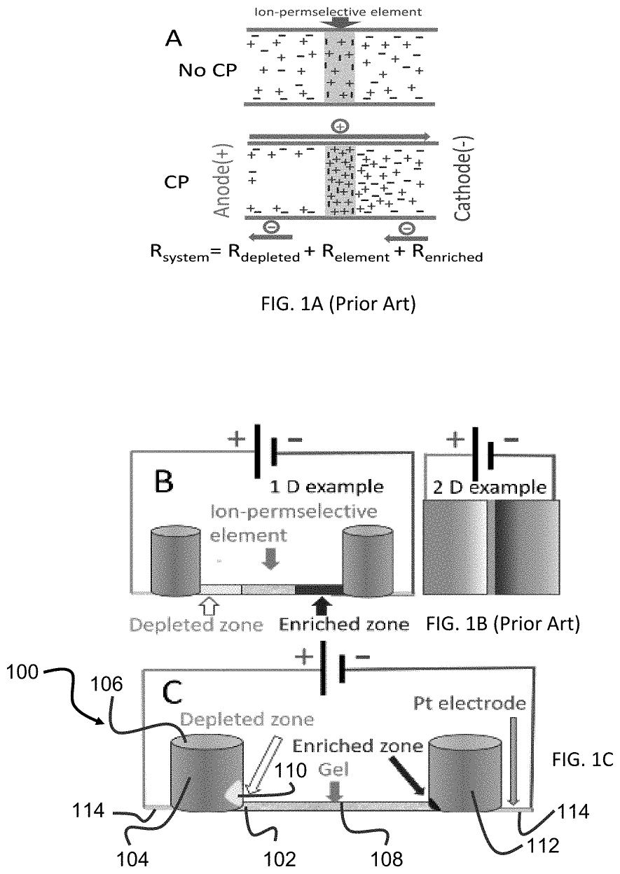

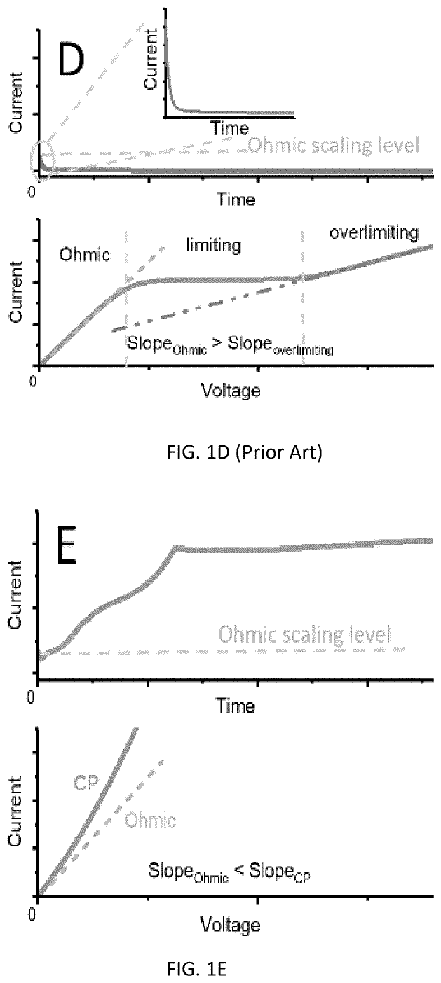

FIG. 1C shows a preferred electrodialysis fluid purification device 100. The device includes a feed fluid supply 102 into a first fluid reservoir 104. A fluid output is taken from an upper part 106 of the first fluid reservoir 104. In FIG. 1C, an enriched gel 108 serves as an ion permselective element and extends to a surface on or near the bottom of the first reservoir 104, and effectively provides a small area point or line interface with the large volume of the first fluid reservoir 104 that creates a depleted zone 110 in the reservoir 104. A fluid connection to a second fluid reservoir is 112 on an opposite side of the enriched gel 108. Electrodes 114 and a power supply create a voltage differential across the one or more ion permselective elements

Preferred embodiments include a depleted zone emanating from microscale permselective element into a 3D macro reservoir as shown in FIG. 1C. In FIG. 1C, a microfluidic channel is interfaced with a side surface of a reservoir near the bottom, and a large depleted zone forms in that reservoir. The much more advantageous shape of typical I-t and I-V plots provided by preferred purification devices is shown in FIG. 1E. Although the current system does not substantially exceed the Ohmic scaling limit in conventional systems, the counter-ion densities in the ion-permselective element of preferred devices are significantly enhanced—e.g., on the order of 50-fold or higher—than the bulk. The enriched zone also has high ion densities and will not limit the current. Therefore, with the high resistance of the depleted zone overcome, a much higher CP current than Ohmic scaling from low applied voltage is obtained. In present devices, the current increases monotonically and remains stable at a high quasi-steady level. The slope of the I-V curve is also larger than the slope of the Ohmic region in conventional systems (FIG. 1E).

In preferred devices, the high resistance of the depleted zone is avoided by releasing the depleted zone from a small cross-sectional area into a larger reservoir (FIG. 1C)—a design that allows for 3D mass transport to the ion-permselective element in a manner analogous to 3D transport to an ultramicroelectrode.

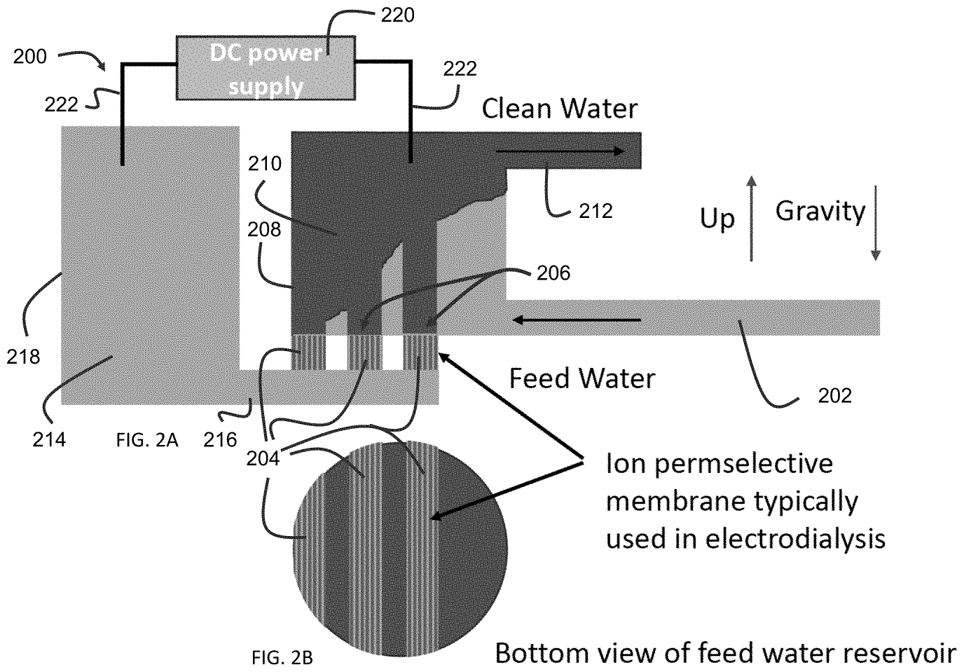

FIGS. 2A-B show a preferred water purification device 200 in respective side schematic and partial bottom views. Feed water (unpure) is fed via a supply 202 to a plurality of elements 204 (or sets of elements) at each of a plurality of small area interfaces 206. Each of the elements 204 or sets of elements is presented edgewise to the volume of a clean water reservoir 208, such that depleted zones and buoyancy provide clean water 210 vertically that can be removed from an upper part/top of the reservoir via a clean water supply 212. Excess ionic unpure/enriched water 214 is removed from the clean water reservoir by an enriched raw water removal tube/channel 216 into an enriched raw water reservoir 218. Counter-ions (having the opposite charge as the immobile/surface charge of the ion permselective element) are transported across each of the ion permselective element 204 or set of ion permselective elements 204 into the enriched raw water reservoir 218. A power source 220 and electrodes 222 that contact the clean water 210 in the clean water reservoir 208 and the excess ionic unpure/enriched water 214 in the enriched raw water reservoir 218 to drive the transport. In the experimental configurations tested the ion permselective element has a negative (anionic) immobile/surface charge and positive species (cations) from the raw water are transported to enriched raw water reservoir 218.

In preferred devices consistent with FIGS. 2A and 2B, the ion permselective element is effectively a point or lines near the bottom of a larger fluid reservoir, and the clean water is removed from the top. Thus, the reduced density caused by both Joule heating and reduction of solute concentration, forces this more buoyant solution to the top the reservoir where it is removed. In preferred devices there is 1) ion permselective element on bottom of the device, and 2) water removal from the top of the device. The ion permselective element is preferably a discontinuous ion permselective element with small/reduced surface area compared to the surface portions of the fluidic reservoir through which it is exposed (e.g., bottom surface or side surfaces near bottom and the bottom surface). The small/reduced surface area can be, e.g. 50% to 1% for example, preferably less than 20% and more preferably less than 10%.

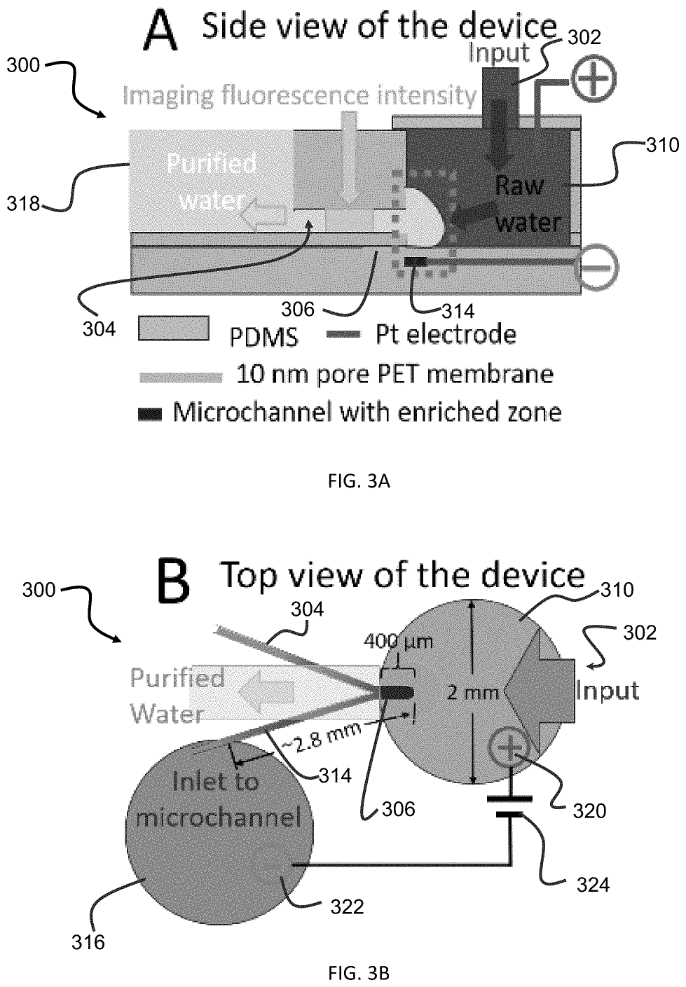

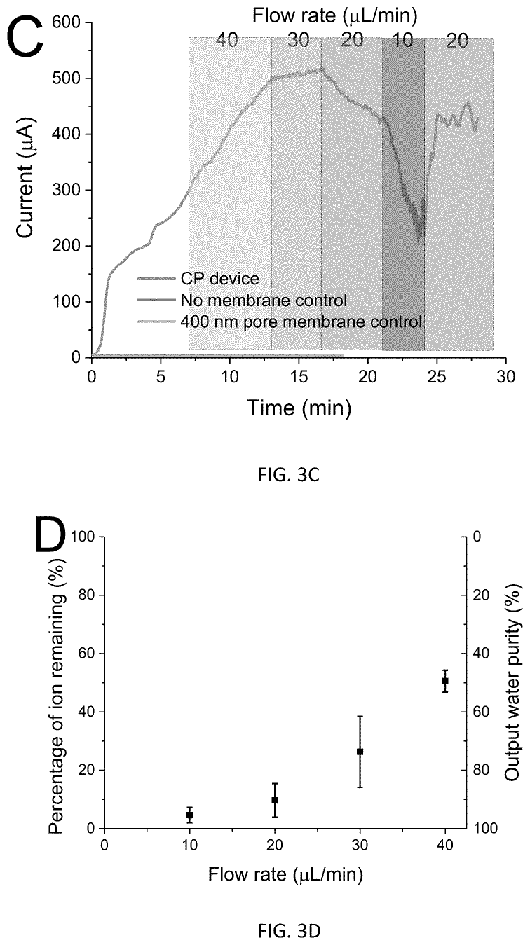

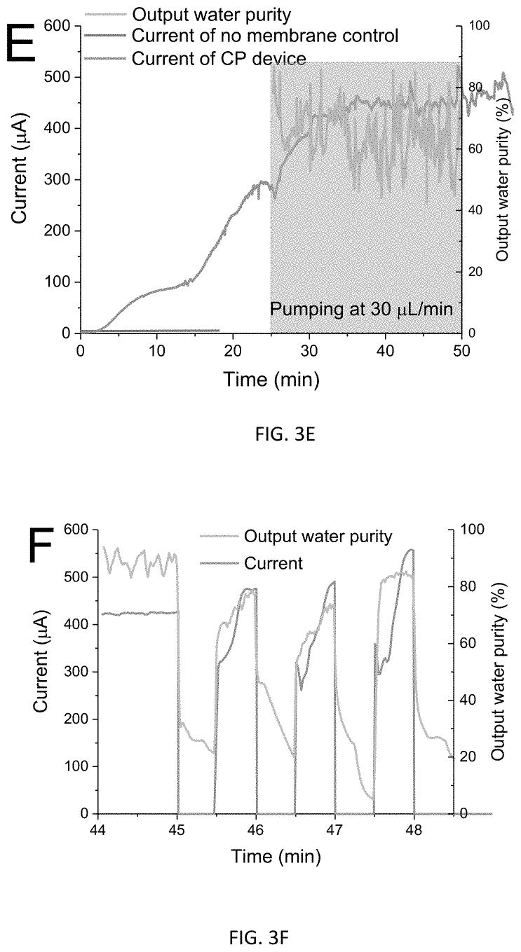

FIGS. 3A-3B side view and top partial views of another preferred water purification device 300. Certain features are shown only in FIG. 3A and others only in FIG. 3B. The device includes a raw water inlet 302 and clean water outlet 304. An ion permselective element 306, e.g., a PET membrane with a 1 nm pore size, can be interfaced through sides of a raw/enriched water reservoir 310, preferably at near its bottom, e.g. in the bottom third of the reservoir 310. A brine/enriched raw water removal tube/channel 314 and brine reservoir 316 permit continuous/long-term (more than an hour or two) stabile operation and a continuous supply of clean water into a clean water reservoir 318. Raw unpurified water is introduced into the reservoir 310 from which the clean water is removed into the clean water reservoir 318. The brine removal tube 304 (corresponding to a brine removal in desalination systems) then provides for removal of the concentrated raw water from raw/enriched water reservoir 310. Electrodes 320 and 322 respectively in the raw/enriched water reservoir 310 and the brine reservoir 316 and a power source 324 drive the ionic transport.

Preferred devices are formed as microfluidic devices in accordance with FIGS. 3A and 3B. Microchannel systems can be classified as 1D because mass transport is confined primarily along the length. Prior conventional electrodialysis systems with large membrane areas in which transport is best described as flux can be classified as 2D. Volumes in reservoirs of preferred devices are classified as 3D. Preferred embodiment devices present a 1D ion permselective element interface to a 3D reservoir volume.

Experimental water purification devices had two PDMS layers and a PET membrane as the ion-permselective element. The top layer has reservoirs and a 360 μm ID tubular channel, moulded with a 360 μm OD capillary, connecting the depleted zone reservoir and the purified water reservoir. a ˜300 μm thick PDMS layer was attached to the top layer via plasma before punching the reservoir, so that the center of the tubular channel is about 500 μm above the bottom of the reservoir. The bottom layer has microchannel (40 μm W×36 μm H) facing up. The smooth PET membrane covers the microchannel, and the top layer is positioned to have a 400 μm long microchannel section fluidically connected to the above reservoir. The microchannel length between the inlet reservoir and depleted zone reservoirs is 2.8 mm.

The FIG. 3A & 3B design has the advantage of utilizing small area membranes as the area that is fluidically connected is (in an experimental device the PET membrane was 80 μm W×400 μm L). Experimental results are shown in FIGS. 3C-3F. The ability of the device to remove an ionic species was demonstrated with the removal of a fluorescent dye, Alexa Fluor 488 in 10 mM NaHCO₃ with an applied potential of 50 V. The CP develops before turning the pump on at 7 min (FIG. 3C) and at 25 min (FIG. 3E). The intensity of the Alex Fluor 488 fluorescence in the clean water stream and the current is measured as a function of time and flowrate. Lower fluorescent intensity indicates greater removal of ionic species.

As controls, devices with no-membrane and 400 nm pore membrane that does not induce CP are used. The no-membrane and 400 nm pore membrane devices produce currents of (4.2±0.3) μA and (3.3±0.2) μA, while the CP inducing water purification device produces a current of (474±31) μA, which is more than 100-fold greater than both controls.

The purity of the clean water is proportional to the flowrate. As shown in FIG. 3C, raw water is pumped into the system and purified water produced at flow rates from 10 to 40 mL/min. Slower flow rates result in higher water purity (FIG. 3D). At 30 μL/min, the contaminant removal rate (water purity) is 73.7±12.2%, and at 10 μL/min, the number is 95.4±2.65%. The system is stable, even without removal of the water with concentrated contaminants, for at least 25 min as shown in FIG. 3E. FIG. 3F presents the correlation between the current and water purity, proving that the purification is directly related to the applied electric field and the depleted zone. The energy required for the system can be reduced by shortening the 2.8 mm microchannel. Gravity can be used to replace a syringe pump that was used to feed the input water flow.

The ion permselective elements used in preferred embodiments can be commercial membranes, such as membranes from 10 nm pore size polyester (PET) membrane (23 μm thick with pore density of 4E09·cm⁻²) was from it4ip S.A. (Belgium). Generally, the ion-permselective element can be any charged nanoporous material. Nanoporous gels can also be used as ion permselective elements, as in FIG. 1C and are considered a form of such elements in this description.

Experiments Regarding Depleted Zone

The following experiments and discussion of the same demonstrate the creation of depleted zones in preferred devices and methods of the invention.

In preferred embodiments, to obtain high currents, an ion permselective element with a microscale cross-section is interfaced with a macroscale reservoir. Confocal fluorescence microscopy and microparticle tracking velocimetry (μ-PTV) were used to characterize the depleted zone that emanates vertically from the CP inducing nanoporous gel into the macroscale reservoir. The shape and growth of depleted zone and velocity in the surrounding bulk solution are consistent with natural convection being the driver of the depleted zone morphology and eliminates the high resistance created by the depleted zone in 1D and 2D systems. Once the resistance of the depleted zone is negated, the high currents are believed to result from enhancement of counter-ion concentration in the nanoporous gel-filled microchannel. In contrast with conventional systems, the current increases monotonically and remains stable at a high quasi-steady level in the reported systems. These results may be used to increase the efficiency and performance of future devices that utilize CP, while the ability to collect purified water with this geometry is demonstrated.

Experiments were conducted regarding the CP and depleted zone with the micro to macroscale interface used in example water purification devices. We used nanoporous gel as the ion-permselective element to fill the microchannel that connects to the 3D reservoir with different lengths to elucidate the mechanism. The planar design of the system allowed for imaging of the depleted zone and characterization of advection using micro-particle tracking velocimetry (μ-PTV). The depleted zone shape and currents were measured with the device in upright and upside-down orientations to probe the effects of buoyancy-driven flow on the shape of the depleted zone. We demonstrated a greater than one order of magnitude increase in current, and also through confocal imaging and μ-PTV, provided substantial insight into the mechanisms that provide improved current and mass transport. Based on this mechanism, we fabricated the micro water purification system with a 10 nm pore polyester (PET) membrane as the ion-permselective element shown in FIGS. 3A and 3B.

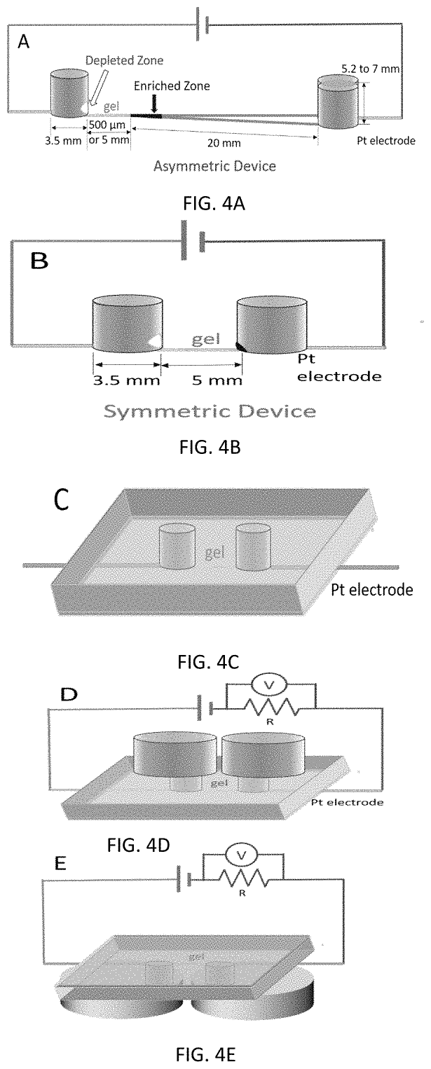

Microfluidic devices were fabricated using PDMS as previously with a curing time of a least 3 days according to known techniques. Schematics of the devices are shown in FIGS. 4A-4E. The bottom of the device was formed with a thin PDMS layer (˜300 μm) coated on rectangular cover glass (50 mm×22 mm×0.2 mm). The top layer contains the microchannels (200 μm W×36 μm H) and reservoirs with a total thickness of 5.2˜7 mm. The devices imaged with both upright and upside-down orientations had a ˜1.8 mm thick top layer. Reservoirs with a ˜3.5 mm ID were cut into the PDMS with a 4 mm diameter biopsy punch. Two slits were cut between the reservoirs and the edge of the PDMS layer to embed two platinum electrodes (wires, 360 μm in diameter) and sealed with uncured PDMS. The top and bottom PDMS layers were attached by surface oxidation through a plasma (BD-20AC laboratory corona treater) for 1 min. The assembled devices were heated at 80° C. overnight.

The negatively charged nanoporous gel was formed via in-situ photopolymerization. FIGS. 4A-4E show: (A) Dimensions of the asymmetric device. (B) Dimensions of the symmetric device. (C) Schematic of the PDMS device. (D) Schematic of the current measurement circuit with normal orientation. (E) Schematic of the current measurement circuit with inverted orientation. The microchannel was first saturated by 20% benzophenone in acetone. The gel precursor solution contained 3 M acrylamide, 0.3 M N,N′-methylenebisacrylamide (%T=23.7% wt/vol), 0.075 M 2-acrylamido-2-methylpropane sulfonic acid, and 5% 2-methyl-4′-(methylthio)-2-morpholinopropiophenone in DMSO. The neutral gel was made with 3 M acrylamide, 0.375 M N,N′-methylenebisacrylamide, and no 2-acrylamido-2-methylpropane sulfonic acid. After polymerization, the gel in reservoirs was removed, and the devices were stored in water.

Current Measurement

The microfluidic devices were filled with buffer containing 3 mM Na₂HPO₄, 2 mM NaH₂PO₄, and 5 mM NaHCO₃ with a pH of 7.5. The NaHCO₃ inhibits water hydrolysis and reduces bubble formation at the electrodes. Large plastic reservoirs that hold 1 mL buffer were added to the top of each device operated in the normal (upright) orientation (FIG. 4D). In the upside-down orientation (FIG. 4E), reservoirs with a 3.5 mL capacity were used. A DC voltage was supplied by a high voltage amplifier (Trek® model 2220) with the anode (positive end) always on the side where the nanoporous gel interfaces the macroscale reservoir except the experiments represent conventional systems. Normally 100 V was applied to long microchannel devices, while 30 V was applied to short microchannel devices to keep their open channel current the same. As shown in FIG. 4D, the current is calculated from the voltage drop measured across a 4.7 kΩ resistor and applying Ohm's law. For current-voltage (I-V) plots, each voltage was held for 15 min and the current during the last minute was averaged as the final results. Each experiment type was repeated with at least three devices.

Imaging

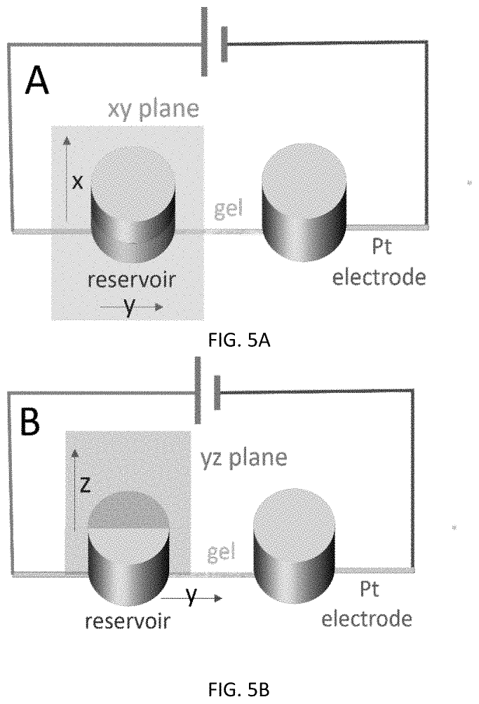

A confocal microscope system (Leica SP8) was used to image the ion depleted zone in the reservoir. Both XYZT and YZT scan modes were used (FIGS. 5A and 5B). The y-axis is centered within the microchannel containing the nanoporous gel, and the z-axis=0 at the interface of the device substrate and the solution (FIG. 5B). A 10× objective lens was used in most experiments, providing an optical section (the resolution along the z-axis) ˜7.7 μm in XYZT scans and ˜0.74 μm in YZT scans. The fluorescent dyes were only added to the anodic reservoir. Details of the following experiments are summarized in Table 1:

TABLE 1
Experimental details of confocal fluorescent imaging.

| Experiment | #1 | #2 | #3 | #4 | y-z μ-PTV |
|---|---|---|---|---|---|
| Fluorescent | 8 μM | 100 nM | 100 nM | 500 nM | Carboxylate- |
| tracer | Rhodamine | Alexa Fluor | Alexa Fluor | Alexa Fluor | modified |
| | 6G | 594 | 594 | 594 | 1.0 μm |
| | 5 μM | | | | fluorescent |
| | Alexa Fluor | | | | microspheres |
| | 594 | | | | (7.2 × 10⁷/mL) |
| | | | | | and 100 nM |
| | | | | | Alexa Fluor |
| | | | | | 594 |
| Scan type | XYZT | XYZT | YZT | XYZT | YZT |
| | | | | YZT | |
| Scan size¹ | 600 × 600 | 1550 × 1550 | 400 × 400 | 1550 × 1550 | 400 × 400 |
| (μm × μm) | | | | (XYZT) | |
| | | | | 400 × 400 | |
| | | | | (YZT) | |
| Spatial | 1.17 × 1.17 | 3.03 × 3.03 | 0.783 × 0.783 | 3.03 × 3.03 | 0.783 × 0.783 |
| resolution | | 1.52 × 1.52 | | (XYZT) | |
| (μm × μm) | | | | 0.783 × 0.783 | |
| | | | | (YZT) | |
| Scan range at | 50 | 1800 | | 1332 | |
| z-axis in | | | | | |
| XYZT² | | | | | |
| (μm) | | | | | |
| Scan time | 39 s/stack | 53 s/stack | 1.49 s/frame | 39 s/stack | 0.72 s/frame |
| | | | | (XYZT) | |
| | | | | 1.49 s/frame | |
| | | | | (YZT) | |

¹It's x-y plane for XYZT scan and y-z plane for YZT scan.
²All of the XYZT scans have z-axis step size of 36 μm except experiment#1, which is 5 μm.

First, 8 μM Rhodamine 6G (R6G) and 5 μM Alexa Fluor 594, as cation and anion tracers, respectively, were imaged simultaneously. A series voltage (0 V, 5 V, 15 V, 30 V, 50 V, 75 V, and 100 V) was applied with long microchannel devices, and each lasted for 5 min. The dyes were excited with 488 nm, 514 nm, and 561 nm laser lines. Three photomultipliers (PMT) were used to simultaneously collect light from R6G (571-595 nm), Alexa Fluor 594 (620-751 nm), and bright-field channels. Second, the time-dependent size and shape of the depleted zone were acquired with XYZT scans with 100 nM Alexa Fluor 594. One stack with 0 V images was taken before the voltage was applied. A potential of 30 V was applied to short microchannel devices for 60 min, and 100 V was applied to long microchannel devices for 90 min followed by the application of 5 V for 15 min. Third, the depleted zone shape was imaged in the vertical plane through the center of the reservoir and microchannel using YZT scans with Alexa Fluor 594. A series of voltages (5 V, 15 V, and 30 V) were applied for at least 11 min respectively in short microchannel devices. Each voltage step was separated by steps of 0 V for at least 5 min to allow for re-equilibration. Fourth, the effects of flipping the vertical orientation of the device were investigated by imaging the distribution of Alexa Fluor 594 with the device in upright and upside-down orientations. The devices with long microchannel and 2 mm device thickness were examined at 100 V. With the smaller reservoirs (˜20 μL), the cohesive forces/surface tension holds the liquid in the PDMS reservoir in the upside-down orientation. A 100 μm thick PDMS membrane was used to cover the reservoirs to prevent solution evaporation. After each experiment, the devices were stored in water for 3 days to provide time for re-equilibration.

μ-PTV

The advection in the macroscale reservoir in horizontal planes was characterized using x-y plane μ-PTV at a potential of 100 V with 75 μL reservoirs. Carboxylate-modified 1.0 μm fluorescent microspheres with a density of 7.2×10⁷/mL were used as tracers. The μ-PTV setup included an inverted microscope, halogen lamp, a 10× magnification objective, a 4MP Miro 340 camera (Amtek), and an 80 W diode-pumped laser. Images were collected at 100 fps with a distance-to-pixel ratio of 0.5 μm/pixel. A stair-shaped target of layered PDMS was used to calibrate the z-axis height. The μ-PTV were collected at two z-axis heights (20 μm and 100 μm). The devices were re-equilibrated for 3 days between collecting data at a different height. At each height, the data series were 950 frames each, beginning at 13 min, 27 min, 36 min, and 42 min, corresponding to current about 8 μA, 13 μA, 24 μA, and 33 μA, respectively.

The Leica SP8 confocal system was used to acquire y-z plane μ-PTV data at 1.39 fps. Carboxylate-modified 1.0 μm fluorescent tracer beads with a density of 7.2×10⁷/mL and 100 nM Alexa Fluor 594 were added to the buffer. The microspheres and dye were excited by 514 nm and 561 nm laser lines, and emission collected from 520-750 nm.

Matlab was used to analyze the XYZT stacks from the confocal imaging by calculating the area, volume, and height of the depleted zone. All the images were compared to the 0 V images at the same z-height with 2×2 binning. To determine the depleted zone area, a pixel was considered part of the depleted zone when both: its intensity at high voltage is less than 50% of its intensity at 0 V, and at least four of the eight surrounding pixels that meet the intensity criterion. The depleted zone volume was integrated using the trapz function along the z-direction. The depleted zone height was defined as the height that 95% depleted zone volume lies below.

Image series that monitors the concentration change in the pipe in water purification systems were also analyzed with Matlab. Because the pipe has a cylinder shape, the solution thickness is increased from the two edges to the center, corresponding to the maximum fluorescent intensity in the center. After flat field correction, the initial intensity (raw water fluorescence) of each pixel in the pipe is used to calculate its solution thickness coefficient, which is used as the weight when adding up concentration change at each pixel to calculate the overall concentration change percentage. After the syringe pump started, output water passed through the pipe at set flow rates. Only the images taken at the last minute of a certain flow rate are counted. Output water purity (%)=((raw water fluorescence—output water fluorescence)/raw water fluorescence)×100.

For the x-y plane μ-PTV after preprocessing sequences to remove the background using ImageJ, the position of each tracer bead is determined at the sub-pixel resolution, tracked using the Hungarian algorithm, and linked with three-frame gap closing for longer trajectories in Matlab. The reconstructed trajectories were filtered using fourth-order B splines to minimize the noise in the position detection. The process allows obtaining individual trajectories with the information of Lagrangian velocity and acceleration.

Our experiments and modelling showed that present devices are able to approach the Ohmic scaling limit by negating the resistance of the depleted zone by having depleted zone side boundary of the microscale ion-permselective element interface with a macroscale fluid reservoir. The ion-permselective element is made by filling a microchannel with an ion-permselective nanoporous gel and thus has a microscale cross-section.

The experiments showed that location of the nanoporous gel within the microchannel plays an important role in the current response. We considered four general locations for the nanoporous gel in both long (25 mm) and short (5mm) microchannel devices, as represented in FIG. 7: 1) one end at the macroscale reservoir/microchannel interface is on the depleted zone (anodic) side and the other end within the microchannel (type I, II, VIII), 2) one end at a macroscale reservoir/microchannel interface on the enriched zone (cathodic) side and the other end within the microchannel (type VII), 3) the microchannel is completely filled with the nanoporous gel (type VI), and 4) both ends are fully contained within the microchannel, which is similar to the conventional microchannel (1D) configuration (type III). Both the I-t and I-V plots indicated that the key to achieving the highest current is one end of the nanoporous gel must be located at the macroscale reservoir/microchannel interface on the depleted zone (anodic) side. As the end of the nanoporous gel interface is moved away from the macroscale reservoir/microchannel interface the maximum current rapidly decreases. Moving the end of the nanoporous gel back just 110 μm from the interface (type VII) decreases the current about 7-fold. It causes the current to decrease, rather than increase, as a function of time before reaching a quasi-steady state. Moving the nanoporous gel end at the depleted zone back further produces even lower currents. This data is consistent with observations of Na⁺having a diffusion length of ˜100-200 μm. Adding an open microchannel on the enriched zone side (type I) has little effect on the maximum current reached, but increases the time required to reach quasi-steady-state current. Additional controls, one without any nanoporous gel (open channel, type V & IX) and one with a neutral nanoporous gel (type IV), both produced lower current levels that were largely constant as a function of time.

The results indicate the conductivity of the ion permselective material increases with CP. The increased conductivity can contribute to the high currents observed. The nanoporous gel properties are important as the length and charge both affect the current, as discussed previously. In addition to the high measured currents, the concentration of a cationic dye R6G was observed to increase in the nanoporous gel as a function of time and the high cationic dye concentration was observed. Additionally, the anionic dye is depleted in the gel and both cationic and anionic dyes are excluded from the depleted zone as expected, indicating that nearly all of the current is carried by cations.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. An electrodialysis fluid purification device, comprising
a fluid output from an upper part of a first fluid reservoir;
one or more ion permselective elements at a surface on or near the bottom of the first reservoir, the one or more ion permselective elements being arranged to provide one or more small area points or lines;
a fluid connection to a second fluid reservoir on an opposite side of the one or more ion permselective elements; and
electrodes and a power supply to create a voltage differential across the one or more ion permselective elements.

2. The device of claim 1, wherein the one or more ion permselective elements comprise a plurality of elements at each of a plurality of small area interfaces.

3. The device of claim 2, wherein the plurality of elements is arranged with edges of the elements facing a volume of the first reservoir.

4. The device of claim 1, wherein the one or more ion permselective elements are arranged in one or more microchannels between the first fluid reservoir and the fluid connection to the second fluid reservoir.

5. The device of claim 1, wherein the one or more ion permselective elements comprise an ion-permselective nanoporous gel.

6. The device of claim 1, wherein the wherein the one or more ion permselective elements is interfaced into a side surface of the first reservoir.

7. The device of claim 1, wherein the wherein the one or more ion permselective elements is arranged to create a depleted zone that extends into the first reservoir.

8. The device of claim 7, wherein the depleted zone extends up, away and around edges of the one or more ion permselective elements.

9. The device of claim 1, wherein the wherein the one or more ion permselective elements is configured to create a micro scale interface to a macroscale volume in the first reservoir.

10. The device of claim 1, wherein the one or more ion permselective elements comprises a discontinuous ion permselective element.

11. The device of claim 1, wherein the one or more ion permselective elements presents a small surface area compared to surface portions of a volume of the first reservoir to which it is exposed.

12. The device of claim 11, wherein the small surface area of the one or more ion permselective elements is 50% or less than the surface portions of the volume.

13. The device of claim 12, wherein the small surface area of the one or more ion permselective elements is 20% or less than the surface portions of the volume.

14. The device of claim 11, wherein the one or more ion permselective elements are arranged to present a microscale interface to a macroscale volume of the first fluid reservoir.

15. The device of claim 14, wherein the one or more ion permselective elements are arranged to present edges of the elements to a volume of the first reservoir.

16. The device of claim 15, wherein the microscale interface is a 1D interface and the macroscale volume is a 3D volume.

17. A fluid purification device, comprising a first reservoir with which an ion permselective element interfaces directly in a 2D to 3D relationship, an outlet channel for the clean water in an upper part of the first reservoir, a input channel into the first reservoir for raw water, an outlet channel at or near the bottom of the first reservoir to remove water that is enriched in contaminants, a second reservoir that is in fluid communication with the first reservoir through the ion permselective element, and electrodes to provide an applied electric field between the first and second reservoirs.

18. A method for fluid purification through electrodialysis, comprising:
providing a first reservoir for clean fluid collection and introduction of raw fluid;
arranging small area ion permselective element interfaces at a surface on or near the bottom of the first reservoir such that ion transport creates a depleted zone that extends into the first fluid reservoir;
introducing feed fluid to the interfaces in the first reservoir;
creating ionic fluid transport across the interfaces into the second reservoir; and
collecting clean fluid from an upper part of the first reservoir.
